(19) United States
(12) Patent Application Publication
(10) Pub. No.: US 2007/0024208 A1
(43) Pub. Date: Feb. 1, 2007

(54) Circuit arrangement and method of operating a gas discharge lamp

(75) Inventor: Peter Lurkens, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/571,806

(22) PCT Filed: Sep. 7, 2004
(86) PCT No.: PCT/IB04/51702

§ 371 Date: Mar. 15, 2006

(30) Foreign Application Priority Data
Sep. 17, 2003 (EP) 03103434.1

(51) Int. Cl. H05B 41/36

(52) U.S. Cl. 315/291

(57) ABSTRACT

The invention relates to a circuit arrangement for operating a gas discharge lamp with a current. According to the invention, the current comprises a high-frequency AC component and a low-frequency AC component.

The invention relates to a circuit arrangement and to a method of operating a gas discharge lamp.

A circuit arrangement with a switching converter is known from U.S. Pat. No. 5,608,294. The circuit arrangement comprises a rectifier, a commutator stage with four power transistors, a control unit, and a Buck converter with a switch and a converter inductance. The circuit arrangement is complicated.

A method and a device for operating a high-pressure gas discharge lamp of a data and video projector are known from EP 1 152 645 A1. Electrodes of the gas discharge lamp can be shaped during operation, i.e. structures are grown on the electrodes of the gas discharge lamp, during operation with alternating current and an additional pulse before the zero passage. The size of the structures is dependent on the operating frequency of the current. The diameter of the grown structures is smaller in proportion as the operating frequency is higher. The structures at the tips of the electrodes can accordingly be built up such that an arc length can be reduced at operating frequencies of 45, 65, 90, and 130 Hz, in which case the burning voltage of the lamp drops. At the same time, it is observed that the arc position establishes itself in an exactly defined location in the presence of the tip structures, so that the arc no longer changes its position in leaps during subsequent operation, which would lead to visible flickering effects in the represented image of a video projector fitted with such a lamp. Ultra-high-pressure gas discharge lamps of the UHP and HID types were used. UHP is short for Ultra High Pressure or Ultra High Performance. HID is short for High Intensity Discharge. These lamps are operated for projection purposes with a low-frequency alternating current in a range from 45 to 500 Hz. Given a pure square-wave current shape, i.e. the absolute value of the current remains the same in time, only the sign changes, the luminous power will indeed remain constant in time, but the stability of the arc position is not guaranteed. The burning stability of the lamp is indeed increased in the case of a current waveform with additional pulses, but now a luminous power constant over time cannot be achieved anymore.

The invention accordingly has for its object to provide a simple circuit arrangement and a simple method of operating a gas discharge lamp.

This object is achieved by the characterizing features of the parallel independent claims 1 and 10. According to the invention, the current comprises a high-frequency AC component and a low-frequency AC component. The current is formed by a superposition of two or more alternating currents of different frequencies, wherein a first AC current component has a high frequency and a further AC component a low frequency. A simpler circuit construction can be used in the operation of a gas discharge lamp with a high frequency. No acoustic oscillations or mechanical oscillations occur in the gas discharge if the lamp is operated at a sufficiently high frequency, well above 1 MHz in the case of a UHP lamp, with the result that the discharge arc is acoustically stable, but two negative effects are observed. At a higher power, the discharge arc applies itself to the electrode in a planar shape, i.e. the arc operates in the so-termed diffuse mode. The position of the discharge arc inside the lamp does indeed change slowly, so that the projection is not disturbed, but the electrodes are burned back very quickly, which shortens lamp life. At a lower power, the arc applies itself to the electrode in a point shape, i.e. contracted, so that the arc burns in the contracted mode. Burning-back of the electrode is weak, comparable to low-frequency operation, but the arc position is unstable, which leads to frequent position changes of the arc. This in its turn is visible as a disturbing flickering in the image. An intensive plasma streak is often observed in this operating mode, pointing upwards in the center of the lamp and hitting the quartz wall there in a concentrated manner. A zone develops here during subsequent lamp life in which the quartz changes from the amorphous to the crystalline state, i.e. it recrystallizes. The recrystallized quartz is no longer lucid but milky. This scatters the light, so that the projection brightness is reduced. In addition, the quartz wall is weakened in this location, which finally leads to a shorter lamp life. The energy balance of the electrodes in gas discharge lamps depends on the current direction, as in electrolysis. The current in the discharge is mainly an electron current, because the electrons are substantially more mobile in the plasma than the heavy gas ions. The electrons must receive a certain excitation energy, also denoted work function, in order to leave the negative electrode or cathode. They give off this energy again when hitting against the anode, so that the cathode is somewhat cooled by the electrons flying away therefrom, whereas the anode is heated. In AC operation the electrodes change their function cyclically, i.e. are the anode for some time and then the cathode, and then again the anode, etc. The different states at the electrodes dependent on the current direction in lamps with low-frequency operation lead to associated transitions between a diffuse and a contracted arc attachment. The high frequency in high-frequency operation has the result that the arc attachment remains practically unchanged. This is changed, however, when a certain low-frequency current is added again. A temperature modulation now arises which takes place anti-cyclically in the two electrodes. This is to say, when one electrode has a temperature maximum, the other one has a minimum. This now has the result that the contraction state of the arc attachment at the two electrodes is unequal. In particular, the arc is diffuse at one electrode whereas it is contracted at the other one. No plasma streak is observed anymore now, and recrystallization does not occur. At the same time, elevations are formed on the electrodes, and a stabilization of the arc position establishes itself. It was found that the power in the low-frequency range required for this effect is considerably lower than the high-frequency power, with approximately 10 W as against 120 W. This renders it possible to generate this additional current component with a very low expenditure. The lamp power results from the superposition of low-frequency and high-frequency components, also denoted low-frequency and high-frequency signals hereinafter. If the low-frequency signal is sinusoidal, a power modulation will arise again, although substantially smaller, with a corresponding waveform of the luminous power. This does not occur anymore if a square-wave oscillation is advantageously used for the low-frequency current. In this case the instantaneous power in the low-frequency range is constant, whereas the power oscillations in the high-frequency range of 13 MHz are so fast that they do not lead to any luminous fluctuations at all anymore because of the thermal inertia of the plasma.

Advantageously, the high-frequency AC component has a frequency above 1 MHz. It is not until frequencies reach a level of a few MHz that no acoustic resonances arise in UHP lamps which would lead to arc instabilities. Such instabilities render the light quality useless for projection purposes, while in particularly serious cases the lamp may even be destroyed.

Advantageously, the low-frequency AC component has a frequency below 1 kHz.

In a simple case, the high-frequency AC component has a sinusoidal current waveform.

Advantageously, the high-frequency and the low-frequency AC components can each be supplied from a respective current source. A separate current source is thus available for the high-frequency and the low-frequency component.

Advantageously, a decoupling is present between the high-frequency and low-frequency current sources.

An embodiment of the invention will now be explained in more detail below for better understanding with reference to the drawing, in which:

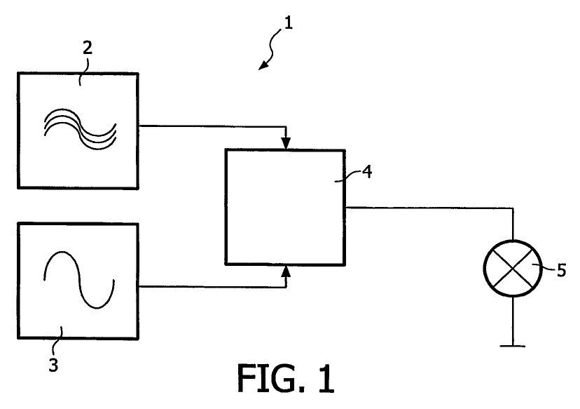

FIG. 1 shows a circuit arrangement for operating a gas discharge lamp,

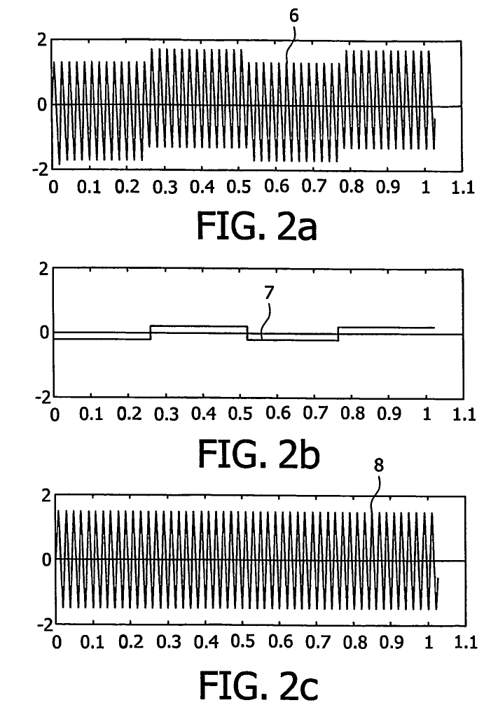

FIG. 2a is a time diagram of a lamp current with a high-frequency and a low-frequency AC component being superimposed,

FIG. 2b is a time diagram of the low-frequency AC components, and

FIG. 2c is a time diagram of the high-frequency AC components.

FIG. 1 shows a circuit arrangement 1 which comprises a high-frequency current source 2 and a low-frequency current source 3, a decoupling 4, and a UHP lamp 5. The high-frequency current source 2 having a frequency above 1 MHz essentially makes the electric power of 120 W necessary for operating the lamp 5 available. The decoupling 4 prevents the high-frequency and low-frequency current sources 2, 3 from interfering with one another. The low-frequency current source 3 supplies a weak alternating current with a low power of 0.2 A and 2 W. The two current components are superimposed in the decoupling 4 and supplied to the lamp 5. The low-frequency current source 3 has an influence on gas flows inside the lamp 5 such that said flows no longer hit a certain point of a lamp vessel, or lamp bulb, in a concentrated manner anymore, but are better distributed. This reduces the temperature load on the lamp bulb. In addition, the arc position is stabilized thereby.

FIGS. 2a, 2b, and 2c show a lamp current 6 which is composed of a low-frequency current component 7 and a high-frequency current component 8. For reasons of clarity, the high-frequency current is depicted with a substantially lower frequency in relation to the low-frequency current than is required in practice.

### LIST OF REFERENCE NUMERALS

1 circuit arrangement
2 high-frequency current source
3 low-frequency current source
4 decoupling
5 UHP lamp
6 lamp current
7 low-frequency current component
8 high-frequency current component

1. A circuit arrangement (1) for operating a gas discharge lamp (5) by means of a current, characterized in that the current (6) comprises a high-frequency alternating current component (8) and a low-frequency alternating current component (7).

2. A circuit arrangement as claimed in claim 1, characterized in that the high-frequency alternating current component (8) has a frequency above 1 MHz.

3. A circuit arrangement as claimed in claim 1, characterized in that the low-frequency alternating current component (7) has a frequency below 1 kHz.

4. A circuit arrangement as claimed in claim 2, characterized in that the high-frequency alternating current component (8) has a sinusoidal current waveform.

5. A circuit arrangement as claimed in claim 3, characterized in that the low-frequency alternating current component (7) has a square-wave current waveform.

6. A circuit arrangement as claimed in claim 1, characterized in that the high-frequency alternating current component (8) can be supplied from a current source (3).

7. A circuit arrangement as claimed in claim 1, characterized in that the low-frequency alternating current component (7) can be supplied from a further current source (2).

8. A circuit arrangement as claimed in claim 1, characterized in that the low-frequency alternating current source is designed such that an arc attachment changes at least once between a diffuse state and a contracted state within one low-frequency cycle.

9. A circuit arrangement as claimed in claim 1, characterized in that a decoupling (4) is arranged between the high-frequency and the low-frequency current source (2, 3).

10. A method of operating a gas discharge lamp (5) with a current, characterized in that the current is formed by a superposition of two or more alternating currents (7, 8) of different frequencies, wherein a first alternating current component (8) has a high frequency above 1 MHz and a further alternating current component (7) has a low frequency below 1 kHz.

11. A lighting system comprising a circuit arrangement (1) as claimed in claim 1.

12. A data and video projector comprising a circuit arrangement (1) as claimed in claim 1.
